(19) United States
(12) Patent Application Publication
(10) Pub. No.: US 2002/0180108 A1
(43) Pub. Date: Dec. 5, 2002

(54) Electromagnetic shielding box and method of manufacturing the same

(76) Inventor: Kiyofumi Koshiba, Toyama-ken (JP)

Correspondence Address: FLYNN, THIEL, BOUTELL & TANIS, P.C., 2026 Rambling Road, Kalamazoo, MI, 49008-1699, US

(21) Appl. No.: 10/135,870

(22) Filed: Apr. 30, 2002

Related U.S. Application Data
(63) Continuation-in-part of application No. 09/835,677, filed on Apr. 16, 2001, now abandoned.

(51) Int. Cl. B29C 39/22; B29B 7/00

(52) U.S. Cl. 264/328.1; 264/299

(57) ABSTRACT

There are provided a method of manufacturing an electromagnetic shielding box having sufficient yield strength or proof stress such that electronic devices accommodated therein are not affected by an external electromagnetic wave and an electromagnetic wave produced in the electromagnetic shielding box does not escape outside thereof. The method of manufacturing an electromagnetic shielding box comprises the steps of using a wire net having meshes or metal plate having through holes serving as an electromagnetic shielding member to be inserted into a wall body comprising first half body and a second half body of a wall body of a box, pressing the wire net or the metal plate against a first mold serving as first half wall body to define a first cavity between the wire net or the metal plate and the second mold serving as the second half body, then filling fused polymer in the first cavity, thereby molding the first half wall body by injection molding to which the wire net or the metal plate is fixed, and moving the first mold away from the wire net or the metal plate to define a second cavity between the wire net or the metal plate and the second mold serving as the second half body, then filling fused polymer in the second cavity, thereby molding the second half wall body by injection molding, and sandwiching the wire net or the metal plate by first and second half wall bodies, and coupling them via the meshes of the wire net or the through holes of the metal plate.

This application is a continuation-in-part of U.S. patent application Ser. No. 09/835,677, filed Apr. 16, 2001, and incorporates by reference the entire disclosure thereof.

### BACKGROUND OF THE INVENTION

1. Field of the Invention

The invention relates to a method of manufacturing an electromagnetic shielding box for protecting a computer from an electromagnetic wave and for preventing erroneous operation of the computer by accommodating the computer in the electromagnetic shielding box in which a electromagnetic shielding member is embedded as a layer in the wall body of the box.

2. Related Art

Technologies associated with variety of computers are developed, and the computers or electronic devices (hereinafter referred to as electronic devices) are arranged to be close to one another, causing a problem that these electronic devices are affected by an electromagnetic interference wave, resulting in erroneous operations of the electronic devices. It is important that the electronic devices are placed under two environment conditions (a so-called electromagnetic consistency), namely, the first environment condition is to take measures not to create disturbance even if they receive an electromagnetic interference wave, and the second environment condition is to take measures not to produce electromagnetic interference wave for affecting other electronic devices, and hence an electromagnetic shielding box is used as means for obtaining these two environment conditions. There are various types for the electromagnetic shielding box of which a type having a wire net or metal plate embedded in a wall body can obtain uniform shielding effect, and has a great advantage.

For means for embedding an electromagnetic shielding member in a wall body of a box, there has been conventionally employed insert molding. According to the insert molding, it is difficult to fix the electromagnetic shielding member in a mold so as to resist against a pressure when a material of the electromagnetic shielding member is introduced into the mold, particularly if the electromagnetic shielding member is formed of the wire net, it is prone to be deformed, and hence it has been difficult to embed the metal wire, the metal plate in the entire surface of the box. Accordingly, there is a proposal to laminate the wire nets on the entire surface of the box (Japanese Utility Model Publication No. 1-76097).

The proposal disclosed in this publication uses metal thin wire which are woven for forming the wire net serving as the electromagnetic shielding box member, and which are made of woven thermoplastic fibers or threads. According to this proposal, if heat pressing is applied to the wire nets which are laminated on a base body (box) made of thermoplastic resin, the thermoplastic fibers or threads are molten or fused together in the base body, so that the net base formed by the metal thin wires alone is embedded in the interior of the upper layer of the base.

However, according to the method of manufacturing such an electromagnetic shielding box, although the wire net serving as electromagnetic shielding member is embedded in the base, which is however applied only to the surface layer at the shallow depth of the box, and hence the wire net can be viewed from the surface, resulting in the occurrence of problems that it is not good in appearance and the wire net is broken by strong shock or acid, thereby losing shielding effect.

### SUMMARY OF THE INVENTION

The invention has been developed in view of the foregoing circumstances and it is an object of the invention to provide a method of manufacturing an electromagnetic shielding box which is molded by an injection molding, and capable of stably holding the electromagnetic shielding member made of a wire net or metal plate in a mold, and embedding the electromagnetic shielding member even in the relatively deep middle position inside the wall body, thereby manufacturing the electromagnetic shielding box capable of forming a safe shielding layer.

To achieve the above object, the method of manufacturing an electromagnetic shielding box according to the first aspect of the invention is characterized in comprising the steps of using a wire net having meshes serving as an electromagnetic shielding member to be inserted into a wall body comprising first half body and a second half body of the wall body of the box, pressing the wire net against a first mold serving as first half wall body to define a first cavity between the wire net and a second mold serving as the second half body, then filling fused polymer in the first cavity, thereby molding the first half wall body by injection molding to which the wire net is fixed, moving the first mold away from the wire net to define a second cavity between the wire net and the second mold serving as the second half wall body, then filling fused polymer in the second cavity, thereby molding the second half wall body by injection molding, and sandwiching the wire net by first and second half wall bodies, and coupling them via the meshes of the wire net.

The method of manufacturing an electromagnetic shielding box according to a second aspect of the invention is characterized in comprising the steps of using a metal plate having multiple through holes serving as an electromagnetic shielding member to be inserted into a wall body comprising first half body and a second half body of the wall body of the box, pressing the wire net against a first mold serving as first half wall body to define a first cavity between the wire net and a second mold serving as the second half body, then filling fused polymer in the first cavity, thereby molding the first half wall body by injection molding to which the metal plate is fixed, and moving the first mold away from the metal plate to define a second cavity between the metal plate and the second mold serving as the second half body, then filling fused polymer in the second cavity, thereby molding the second half wall body by injection molding, sandwiching the wire net by first and second half wall bodies, and coupling them via the through holes of the metal plate.

According to the first and second aspects of the invention, the injection molding comprises two steps comprised of a first step wherein one half wall body having the wire net or metal plate at one surface thereof is injection-molded, and the second step wherein the other half wall body is injection-molded so as to sandwich the wire net or metal plate between both half wall bodies. The wire net or metal plate is held by the mold when it is pressed by and jointed with the mold at the first stage injection molding, then it is coupled with the other half wall at the second stage injection molding.

With the arrangement set forth above, although the electromagnetic shielding member for covering the electronic devices accommodated in a box is embedded in and composite with the wall body of the box at its intermediate layer, since the inner wall body and outer wall body sandwiching the electromagnetic shielding member are integrated with each other via meshes, and hence electromagnetic shielding member is prevented from being broken or corroded, thereby maintaining endurance thereof.

That is, if the shielding member has no perforations (namely, meshes or through holes) when shielding member is subjected to an insert molding with resin (plastic), the resin is divided into an inner wall body and an outer wall body by the shielding member, but the resin penetrates the perforations of the shielding member according to the insert molding of the invention so that the inner wall body and the outer wall body are integrated with each other, and hence the foregoing division can be prevented and the durability and reliability of the shielding member can be remarkably improved as a product.

Further, since the electromagnetic wave absorbed by the electromagnetic shielding members is emitted from the ground sections to the outside, it is not accumulated inside the electromagnetic shielding box, thereby maintaining the proof stress and function even in this respect, and hence the electronic devices inside the box can be protected with safety and an adverse effect to external electronic devices can be prevented.

### BRIEF DESCRIPTION OF THE DRAWINGS

FIG. 1 is a sectional view of a mold used in a first step of a method of manufacturing an electromagnetic shielding box disclosed in the first aspect of the invention;

FIG. 2 is a sectional view of a mold used in a second step of the method of manufacturing the electromagnetic shielding box disclosed in the first aspect of the invention;

FIG. 3 is a sectional view of a wall body of the electromagnetic shielding box disclosed in the first aspect of the invention;

FIG. 4 is a sectional view of a mold used in a first step of the method of manufacturing an electromagnetic shielding box disclosed in a second aspect of the invention;

FIG. 5 is a sectional view of a mold used in a second step of the method of manufacturing the electromagnetic shielding box disclosed in the second aspect of the invention;

FIG. 6 is a sectional view of a wall body of the electromagnetic shielding box disclosed in the second aspect of the invention;

FIG. 7 is a perspective view of an electromagnetic shielding box according to an embodiment of the first embodiment of the invention wherein a part of the electromagnetic shielding box is broken;

FIG. 8 is an enlarged sectional view of the electromagnetic shielding box taken along the arrows X-X in FIG. 7;

FIG. 9 is a perspective view of an electromagnetic shielding box according to another embodiment of the invention wherein a part of the electromagnetic shielding box is broken;

FIG. 10 is a perspective view of an electromagnetic shielding box according to a still another embodiment of the invention wherein a part of the electromagnetic shielding box is broken; and

FIG. 11 is a perspective view of an electromagnetic shielding box according to a more further embodiment of the invention wherein a part of the electromagnetic shielding box is broken.

FIG. 12 is a perspective view showing a part of the electromagnetic shielding member of the electromagnetic shielding box disclosed in the second aspect of the invention.

### DETAILED DESCRIPTION OF THE PREFERRED EMBODIMENT

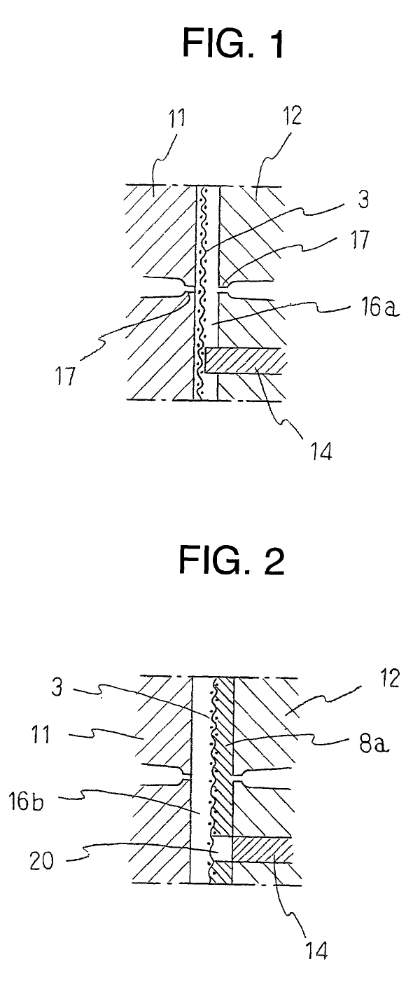

FIGS. 1 to 3 explain a case where a wire net 3 is used as an electromagnetic shielding member, and it is embedded in an intermediate portion of a wall body 8 of a box, wherein gates 17, 17 for injecting thermoplastic fused polymer is formed in first and second molds 11, 12, while a press pin 14 for pressing the wire net 3 is built in the second mold 12 so as to be moved toward or away from the wire net 3.

For the molding step, as shown in FIG. 1, wire net 3 is brought into contact with the first mold 11 to approach the second mold 12, which is stopped by the press pin 14. Accordingly, a cavity 16a is defined between the wire net 3 and the second mold 12, and the fused polymer is filled in the cavity 16a from the gate 17 of the second mold 12.

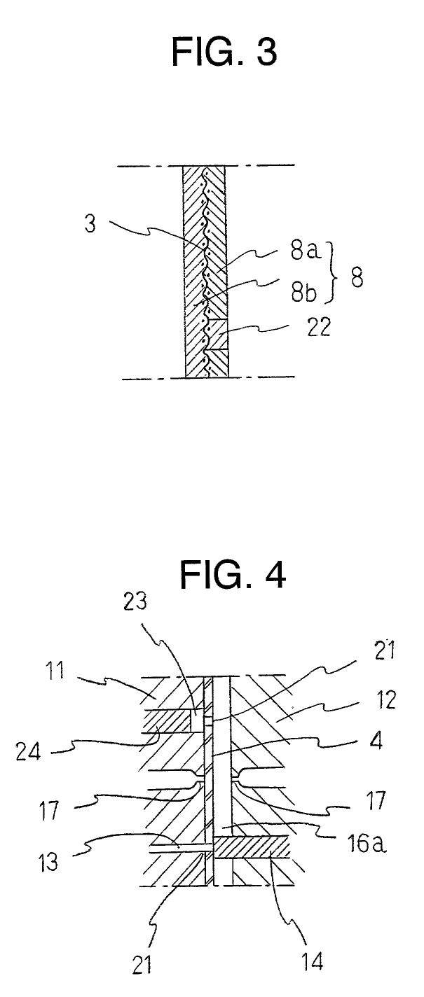

As a result, a first half wall body 8a of the wall body 8 of a box to which the wire net 3 is bonded to one surface thereof is formed. If the first mold 11 is moved away from the wire net 3 in this state, a cavity 16b is defined newly between the wire net 3 and the first mold 11 as shown in FIG. 2. When the fused polymer is filled in the cavity 16b from the gate 17 of the first mold 11, a second half wall body 8b of the wall body 8 of a box is formed, so that the wall body 8 of a box comprising the first half wall body 8a and second half wall body 8b which sandwich the wire net 3 is formed as shown in FIG. 3. Both the first half wall body 8a and second half wall body 8b are integrally combined with each other because fused polymers injected from the gates 17, 17 are entangled with the meshes 7 of the wire net 3. Further, the fused polymer is filled in a let-out 20 of the press pin 14 forming filled part 22, and hence the coupling between the first half wall body 8a and second half wall body 8b can be strengthened by the formation of the partially filled part 22.

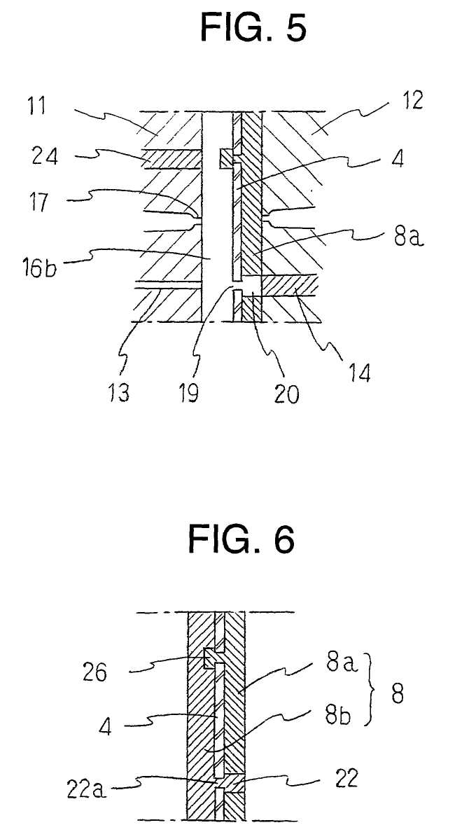

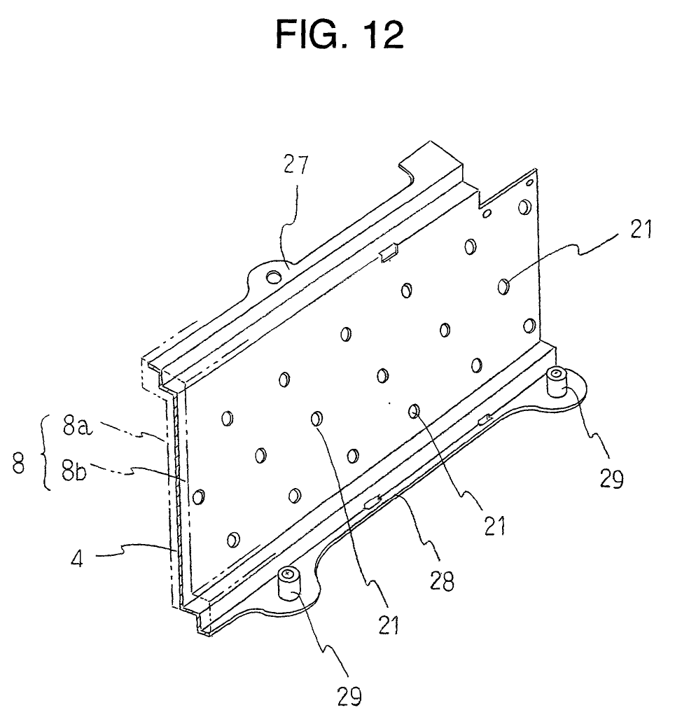

FIGS. 4 to 6 show an embodiment where a metal mesh plate 4 is employed as electromagnetic shielding member. In this case, multiple through holes 21, 21, . . . are defined in the metal mesh plate 4 by press machining (See FIG. 12). Further, the gates 17, 17 are provided in both the first and second molds 11, 12 wherein insertion pins 13, 13, . . . for passing through the through holes 21, 21, . . . are provided in the first mold 11 while press pin 14 is provided in the second mold 12 corresponding thereto. A recess hole 23 through which each through hole 21 is opened is defined in the first mold 11 and a pin 24 for clogging the 23 is defined in the first mold 11. For the molding step, each through hole is first fitted in each insertion pin 13 and the metal mesh plate 4 is brought into contact with the first mold 11 (See FIG. 4). In this state, the fused polymer is filled in the cavity 16a from the second mold 12. As a result, the first half wall body 8a of the wall body 8 of a box is defined between the metal mesh plate 4 and second mold 12 (See FIG. 5), then the cavity 16b is defined between the metal mesh plate 4 and first mold 11 when the first mold 11 is removed from the metal mesh plate 4. Thereafter if the fused polymer is filled in the 17b through the gate 17 of the first mold 11, the first half wall body 8a, second half wall body 8b of wall body 8 of a box for sandwiching the metal mesh plate 4 are formed (See FIG. 6).

Since the fused polymer is filled in a let-out 19 of each insertion pin 13, and the let-out 20 of the press pin 14, both the first half wall body 8a, second half wall body 8b are strongly coupled with each other by the partially filled parts 22, 22a. Further, when the first half wall body 8a of the wall body 8 of a box is first formed, the fused polymer is filled in the recess hole 23 so that the wall body 8 of a box is further strengthened by the a partially filled part 26.

As the electromagnetic shielding members B are members through which an electromagnetic interference wave does not pass and they are typically formed of a metal such as copper, aluminum, iron, metal alloy, or it may be a non-metal material such as conductive rubber, conductive plastic. Further, a “net-like” configuration means porous type or a mesh type configuration such as a wire net, a honeycomb, a punching metal, an expanded metal. If circumstances require, not a net-like configuration but a plate-like configuration may be used as the electromagnetic shielding members. In this case, it is preferable that several through holes are defined in the plate through which resin is introduced so that the plate and resin are integrally molded with each other.

Further, the composition of the electromagnetic shielding members is not limited to one layer but may be plural layers. In this respect, since copper and aluminum is low in resistance value, shield effect is large but there is no magnetic shield effect, and hence it is considered to combine with a shielding member such as iron or ferrite. Even in this case, the box can be freely and easily molded by an insert molding.

Meanwhile, input and output of signals relative to a controller, a computer and so forth, which are accommodated in the box are effected via connectors. The connectors may be separately attached to the box or integrally attached to the box by an insert molding, if need be. Ground sections or other necessary electronic equipments can be connected to external devices by proving the ground sections in the electromagnetic shielding box.

An arbitrary configuration is adopted as a configuration of the electromagnetic shielding box. There is a system for accommodating a plurality of electronic equipments in the electromagnetic shielding box or a system for accommodating automobile ignition devices such as ignition coils one by one separately in the electromagnetic shielding box, and the configuration of the box can be set at an arbitrary one in correspondence with the configuration of the product to be accommodated in the box in such a manner that the electromagnetic shielding box can be easily manufactured with extremely strict economy.

As mentioned above, according to the invention, sine the box is manufactured by molding the electromagnetic shielding member in two steps wherein the wire net or metal plate serving as electromagnetic shielding member is brought into contact with the first mold in the first step, thereby stably holding the electromagnetic shielding member so that the injection molding capable of sandwiching the electromagnetic shielding member between the first and second molds. Accordingly, the electromagnetic shielding member can be embedded even in the intermediate portion having at the deeper position of the wall body, thereby effecting an excellent effect to be able to form a safe shielding layer.

The electromagnetic shielding box B according to a first embodiment of the invention is now described with reference to attached drawings.

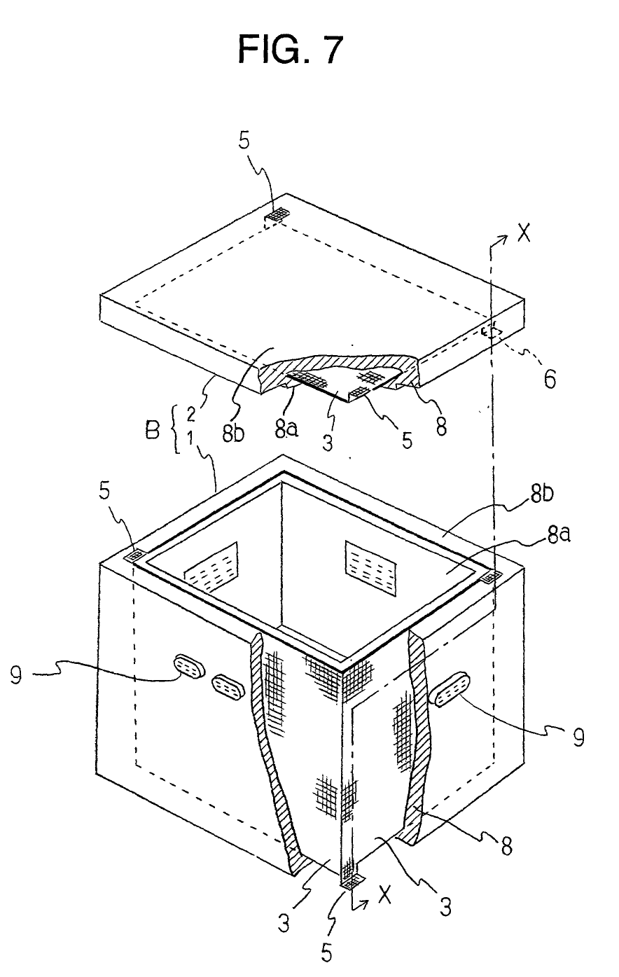

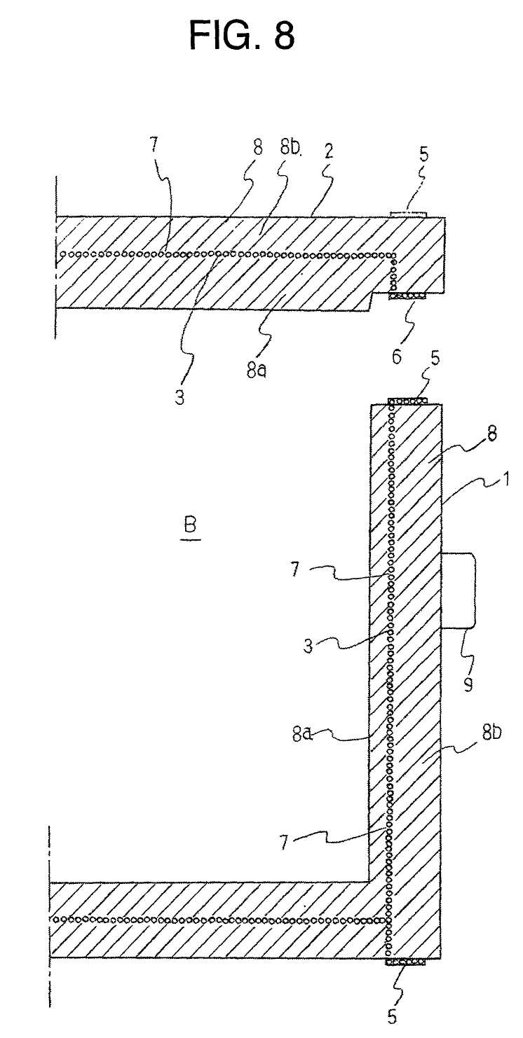

FIGS. 7 and 8 show an embodiment in a case where the electromagnetic shielding member is formed of the wire net 3, wherein the electromagnetic shielding box B comprises a wall body 1 and a cover 2 respectively made of plastic. The wire net 3 is embedded in each wall body of both the wall body 1 and the cover 2 at the intermediate portion thereof by injection molding comprising first and second steps, and becomes composite with the wall body 8 of the box. Ground sections 5 and 6 of the electromagnetic shielding members B are exposed on the upper and lower surfaces of the wall body 1 and the cover 2 and a plurality of connectors 9 having a plurality of terminals are fixed to the side surface of the wall body 1.

The wire net 3 of the wall body 1 is formed in a box shape, and the wire net 3 of the cover 2 is formed of a single piece. The wire net 3 of the cover 2 has the ground section 6 to be connected to the ground section 5 of the wall body 1 and the discharge ground section 5 on the upper surface, and both the ground section 5 and 6 are respectively formed of bent pieces. The first half wall body 8a and second half wall body 8b of the wall body 8 of the box are respectively integrated with each other by meshes 7.

For the use of the electromagnetic shielding box B, for example, the electromagnetic shielding box B accommodates a high-performance computer therein and which is connected to external devices via the connectors 9, which is controlled by an external devices to obtain the output of the computer.

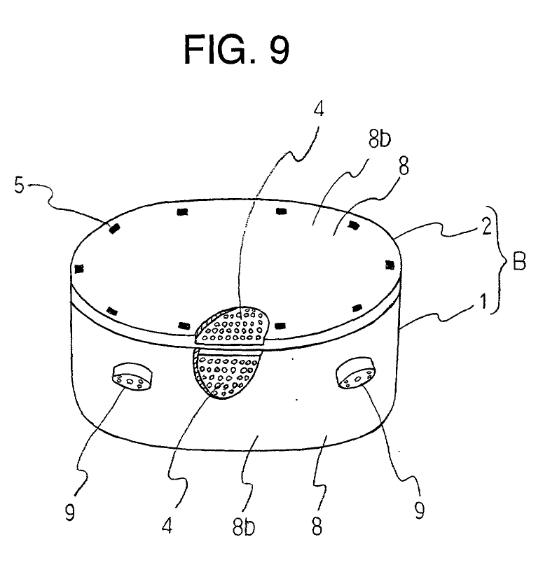

FIG. 9 shows an electromagnetic shielding box B according to another embodiment of the invention. The electromagnetic shielding box is substantially the same as that of the embodiment shown in FIG. 7 except that the electromagnetic shielding box B is circular although it is square according to the embodiment shown in FIG. 7. With this embodiment, as electromagnetic shielding member 3, there is employed a metal mesh plate 4 which is a so-called punching metal formed by perforating a thin iron plate innumerably wherein the metal mesh plate 4 of a body 1 and that of a cover 2 are connected to each other by insertion pins for stopping motion of the cover 2 wherein a head portion of each insertion pin serves as the ground sections 5.

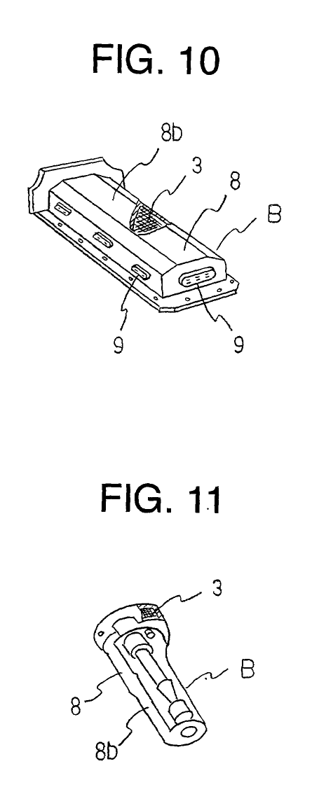

FIGS. 10 and 11 show an electromagnetic shielding box B according to other embodiments of the invention. In the embodiment shown in FIG. 10, the electromagnetic shielding box B is used as a cover of an automobile engine, while it is used as an enclosure of an ignition coil of an automobile, wherein the wire net 3 serving as the electromagnetic shielding members is composite with the cover and the enclosure of an ignition coil by two steps of the insert molding.

FIG. 12 show an embodiment of the second aspect of the invention, wherein electromagnetic shielding member is formed of the metal mesh plate 4. Multiple through holes 21, 21, . . . are defined in the metal mesh plate 4 and bent collars 27, 28 are formed on the upper and lower ends of the metal mesh plate 4. Even in this case, both the first half wall body 8a and second half wall body 8b of the wall body 8 sandwich the metal mesh plate 4 by injection molding in two steps so that they are integrated with each other via each through hole 21. Female screws 29 are attached to the lower end collar 28.

What is claimed is:

1 A method of manufacturing an electromagnetic shielding box comprising the steps of:
using a wire net having meshes serving as an electromagnetic shielding member to be inserted into a wall body comprising first half body and a second half body of the wall body of the box;
pressing the wire net against a first mold serving as first half wall body to define a first cavity between the wire net and a second mold serving as the second half body, then filling fused polymer in the first cavity, thereby molding the first half wall body by injection molding to which the wire net is fixed;
moving the first mold away from the wire net to define a second cavity between the wire net and the second mold serving as the second half wall body, then filling fused polymer in the second cavity, thereby molding the second half wall body by injection molding; and
sandwiching the wire net by first and second half wall bodies, and coupling them via the meshes of the wire net.

2. A method of manufacturing an electromagnetic shielding box comprising the steps of:
using a metal plate having multiple through holes serving as an electromagnetic shielding member to be inserted into a wall body comprising first half body and a second half body of the wall body of the box;
pressing the wire net against a first mold serving as first half wall body to define a first cavity between the wire net and a second mold serving as the second half body, then filling fused polymer in the first cavity, thereby molding the first half wall body by injection molding to which the metal plate is fixed; and
moving the first mold away from the metal plate to define a second cavity between the metal plate and the second mold serving as the second half body, then filling fused polymer in the second cavity, thereby molding the second half wall body by injection molding;
sandwiching the wire net by first and second half wall bodies, and coupling them via the through holes of the metal plate.
